(19) United States
(12) Patent Application Publication
(10) Pub. No.: US 2025/0292375 A1
(43) Pub. Date: Sep. 18, 2025

(54) 2D ARRAY IMAGE FOVEATED PROCESSING METHOD AND ELECTRONIC DEVICE USING THE SAME

(71) Applicants: Chi-Feng LEE, Taipei City (TW); Hong-Yeh HSIEH, Taipei City (TW)

(72) Inventors: Chi-Feng LEE, Taipei City (TW); Hong-Yeh HSIEH, Taipei City (TW)

(21) Appl. No.: 19/223,153

(22) Filed: May 30, 2025

Related U.S. Application Data
(63) Continuation of application No. 17/386,068, filed on Jul. 27, 2021.

(30) Foreign Application Priority Data
Jul. 23, 2021 (TW) 110127245

(51) Int. Cl. G06T 5/70; G06F 3/01; G06T 7/00; G06V 10/25; H04N 19/117; H04N 19/124

(52) U.S. Cl. CPC G06T 5/70; G06F 3/013; G06T 7/0002; G06V 10/25; H04N 19/117; H04N 19/124; G06T 2207/30168

(57) ABSTRACT

A two-dimension (2D) array image foveated processing method and an electronic device applying the same are provided. The 2D array image foveated processing method includes: generating a region of interest (ROI); based on a distance relationship between a target pixel or a target block of a 2D array image to the ROI, generating a processing level parameter of the target pixel or the target block; and performing image region inside processing or image region outside processing on the target pixel or the target block inside or outside the ROI based on the processing level parameter; and compressing the image after being processing by image region inside processing or image region outside processing.

### CROSS-REFERENCE TO RELATED APPLICATION

This application claims the benefit of U.S. provisional patent application Ser. No. 63/057,306, filed Jul. 28, 2020 the benefit of Taiwan patent application Serial No. 110127245, filed Jul. 23, 2021, and the benefit of U.S. patent application Ser. No. 17/386,068, filed Jul. 27, 2021, the subject matter of which are incorporated herein by reference.

### BACKGROUND OF THE INVENTION

### Field of the Invention

The invention relates in general to a 2D array image foveated processing method and an electronic device applying the same.

### Description of the Related Art

Virtual reality (VR) creates a three-dimensional (3D) space through computer simulation. In the virtual reality, the user feels as if he or she were exposed in a real world and were able to observe things in the 3D space in a real-time manner without restrictions.

Now the VR simulation technique has been widely used in many fields, such as work, learning, entertainment or meeting, and has created many application contents. Through the use of the VR simulation technique, the user can overcome the restrictions caused by distance. For example, without going outside, the user can online do his/her daily activities, such as work, healthcare, education and entertainment.

When the user is using a VR or an augmented reality (AR) equipment, the at least one camera built in the equipment enables the user to view the real outside world. Meanwhile, the user pays close attention to a specific region on the screen. The specific region on the screen corresponds to a region of interest (ROI) on the 2D array image of the camera.

Since the bandwidth for internal transmission is restricted, conventional VR equipment needs to perform an operation of image compression operation with high compression ratio on the 2D array image to compress the 2D array image to facilitate internal transmission. When the operation of image compression operation with high compression ratio is performed on the 2D array image, the quality of the entire image will deteriorate and the image will be severely distorted. Also, when the user pays attention to the ROI in the 2D array image, the user will view an ROI with severe distortion and will develop an unpleasant feeling, which in turn will affect the user's experience of using the product.

Therefore, it has become a prominent task for the industries to provide a solution which provides a high quality and undistorted image inside the ROI to the user and improves the user's experience under the circumstances that the bandwidth for internal transmission is restricted, even when the image compression is completed.

### SUMMARY OF THE INVENTION

The invention is directed to a two-dimension (2D) array image foveated processing method and an electronic device applying the same. When performing a foveated processing, the image quality of the target pixel or the target block inside the ROI is substantially maintained, and the image quality of the target pixel or the target block outside the ROI is substantially reduced, such that the volume of image compression can be reduced.

According to one embodiment of the present invention, a two-dimension (2D) array image foveated processing method is provided. The 2D array image foveated processing method includes: generating a region of interest (ROI); generating a processing level parameter of a target pixel or a target block in a 2D array image according to a distance relationship between the target pixel or the target block in the 2D array image and the ROI; and respectively performing an inside image region processing operation or an outside image region processing operation on the target pixel or the target block inside or outside the ROI according to the processing level parameter.

According to another embodiment of the present invention, an electronic device with 2D array image foveated processing is provided. The electronic device includes a foveated processing unit used for generating a region of interest (ROI), generating a processing level parameter of a target pixel or a target block in a 2D array image according to a distance relationship between the target pixel or the target block in the 2D array image and the ROI, and respectively performing an inside image region processing operation or an outside image region processing operation on the target pixel or the target block inside or outside the ROI according to the processing level parameter.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of an electronic device according to an embodiment of the present invention.

FIG. 2 is a functional block diagram of an electronic device according to another embodiment of the present invention.

FIG. 3 is a flowchart of a foveated processing method according to an embodiment of the present invention.

FIG. 4 is a schematic diagram of generating an ROI.

FIG. 5 is a schematic diagram of ROIs and processing level parameters according to an embodiment of the present invention.

FIG. 6A to FIG. 6C are schematic diagrams of processing level parameters according to an embodiment of the present invention.

FIG. 7 is a schematic diagram illustrating the relationship between the filter order and the distance parameter according to an embodiment of the present invention.

FIG. 8 is a schematic diagram of AC truncation according to an embodiment of the present invention.

FIG. 9 is a schematic diagram illustrating the relationship between the truncation position and the distance parameter according to an embodiment of the present invention.

FIG. 10A is a schematic diagram of the quantization parameter or the quantization parameter increment of each block according to an embodiment of the present invention.

FIG. 10B is a schematic diagram illustrating the relationship between the quantization parameter and the distance parameter according to an embodiment of the present invention.

### DETAILED DESCRIPTION OF THE INVENTION

Technical terms are used in the specification with reference to generally-known terminologies used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

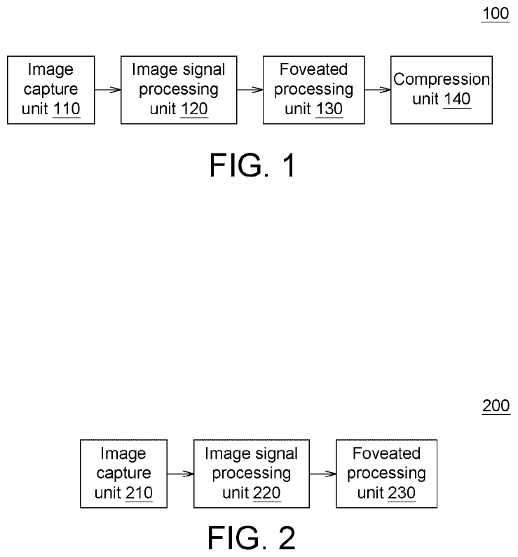

Referring to FIG. 1, a functional block diagram of an electronic device 100 according to an embodiment of the present invention is shown. The electronic device 100 can be realized by but is not limited to a head mounted device. The electronic device 100 includes an image capture unit 110, an image signal processing unit 120, a foveated processing unit 130 and a compression unit 140. The electronic device 100 can be used in a pixel-based processing operation. Detailed descriptions of the electronic device 100 are disclosed below.

The electronic device 100 can be used for processing 2D array image. The 2D array image is provided by the image capture unit 110. In an embodiment of the present invention, the 2D array image can be defined as an image obtained by arranging a plurality of pixels as a 2D array with definitely defined width and height, wherein the minimal unit of the definitely defined width and height is pixel. Each pixel contains one or more than one element. The element can be an R/G/B value representing color, a Y value representing gray level, a D value representing depth, or a combination thereof. The present invention is not limited to the above exemplifications and can have different definitions and combinations in other embodiments.

The image capture unit 110 can be realized by but is not limited to a complementary metal-oxide-semiconductor (CMOS) image sensor.

The image signal processing unit 120 is coupled to the image capture unit 110 for performing image processing on the images captured by the image capture unit 110. Examples of the image processing include but are not limited to image correction, image cropping, and image rotation.

The foveated processing unit 130 is coupled to the image signal processing unit 120. After the foveated processing unit 130 performs a foveated processing operation on the image processed by the image signal processing unit 120, at least one region of interest (ROI) is generated in the image. The foveated processing unit 130 further performs an image region processing operation on the processed image of the image signal processing unit 120. The image region processing operation includes an outside image region processing operation and an inside image region processing operation. The inside image region processing operation substantially maintains the original image quality of the image inside the ROI (for example, maintains the original resolution, that is, substantially performs a compression operation with a lower distortion level or without distortion); the outside image region processing operation substantially performs a foveated processing operation on the image outside the ROI to reduce the image quality (for example, performs a compression operation with a higher distortion level or reduces resolution). In an embodiment of the present invention, defined low distortion compression and high distortion compression are relative. For example, the image inside the ROI maintains the original image quality and the distortion level of the compression operation performed on the image inside the ROI is lower than that of the compression operation performed on the image outside the ROI. The image outside the ROI is processed with the foveated processing operation to reduce the image quality, and the distortion level of the compression operation performed on the image outside the ROI higher than that of the compression operation performed on the image inside the ROI. In an embodiment of the present invention, examples of the foveated processing operation include but not limited to blurring or distortion.

In an embodiment of the present invention, the foveated processing unit 130 can be used in a pixel-based processing operation. During the pixel-based processing operation, the operation is performed in the unit of pixel, therefore the boundary of the ROI can also be defined in the unit of pixel.

The compression unit 140 is coupled to the foveated processing unit 130 for performing an image compression operation on the processed image of the foveated processing unit 130 and then transmitting the compressed image to the back end (such as but not limited to other unit of the head mounted device or an external host).

Referring to FIG. 2, a functional block diagram of an electronic device 200 according to another embodiment of the present invention is shown. The electronic device 200 can be realized by but is not limited to a head mounted device. The electronic device 200 includes an image capture unit 210, an image signal processing unit 220 and a foveated processing unit 230. The electronic device 200 can be used for processing a 2D array image. The electronic device 200 can be used in a block-based processing operation. Detailed descriptions of the electronic device 200 are disclosed below. Besides, during the block-based processing operation, the foveated processing unit 230 can be regarded as inside the compression unit (such as the compression unit 140 of FIG. 1); that is, when performing an image compression operation, the foveated processing operation can also be performed.

The image capture unit 210, the image signal processing unit 220 and the foveated processing unit 230 can be identical or similar to the image capture unit 110, the image signal processing unit 120 and the foveated processing unit 130 of FIG. 1.

In an embodiment of the present invention, the foveated processing unit 230 can be used in a block-based processing operation. During the block-based processing operation, the operation is performed in the unit of block, therefore the boundary of the ROI can also be defined in the unit of block.

In an embodiment of the present invention, through the foveated processing, the electronic devices 100 and 200 can reduce the data volume after compression.

In an embodiment of the present invention, a position of an ROI can be relevant to a user eye watching point (such as the eye watching point of the user wearing a head mounted device) or a position of a tracked object.

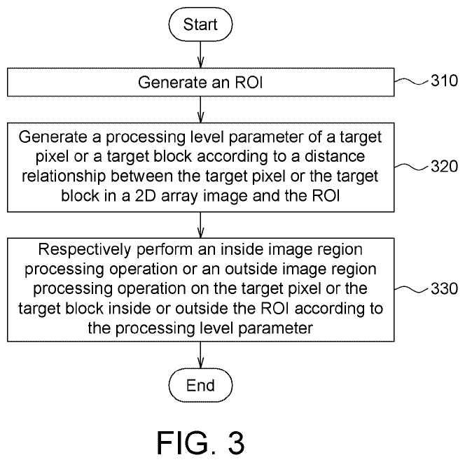

FIG. 3 is a flowchart of a foveated processing method according to an embodiment of the present invention. In step 310, an ROI is generated. In step 320, a processing level parameter of a target pixel or a target block is generated according to a distance relationship between the target pixel or the target block and the ROI in the 2D array image.

In step 330, the inside image region processing operation or the outside image region processing operation is respectively performed on the target pixel or the target block inside or outside the ROI according to the processing level parameter.

Details of each step of the foveated processing method according to an embodiment of the present invention are disclosed below.

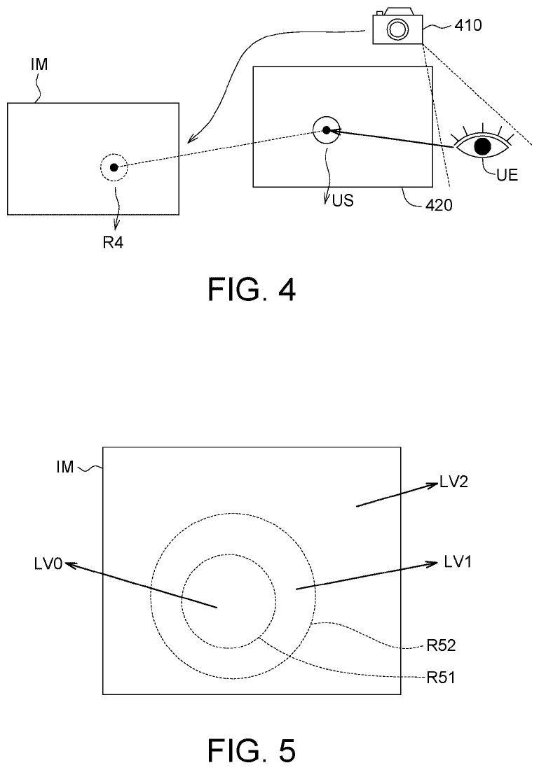

FIG. 4 is a schematic diagram of generating an ROI. As indicated in FIG. 4, the electronic device 200 further includes an eye tracking unit 410 and a display unit 420. The eye tracking unit 410 can track a user watching point US of the user eye UE on the display unit 420 and report the user watching point US for the electronic device 200 to calculate and display the ROI R4 of the image IM on the display unit 420. The electronic device 200 may include 2 eye tracking units 410 (respectively used for tracking the user's two eyes) and 2 display units 420 (respectively used for displaying two images for the user's two eyes). In an embodiment of the present invention, the center point of the ROI R4 is for example the user watching point US of the user eye UE, but the present invention is not limited thereto.

That is, in FIG. 4, the position of the ROI is defined by the user watching point, and the user watching point is generated using an eye tracking technique whose details are omitted here.

In FIG. 4, although the shape of the ROI is exemplified by a circle, the present invention is not limited thereto. In other embodiments of the present invention, the ROI can other shapes, such as a square, a polygon or an arbitrary shape.

Moreover, the range (scope) of the ROI can be adjusted according to actual situations (such as network bandwidth or user's experience). For example, when network bandwidth is not good, the range (scope) of the ROI can be reduced and data can be further compressed, and vice versa; or, when the user's experience is not good, the range (scope) of the ROI can be enlarged, and vice versa.

FIG. 5 is a schematic diagram of ROIs and processing level parameters according to an embodiment of the present invention. As indicated in FIG. 5, at least two ROIs, namely R51 and R52, can be set in the image IM, wherein, the ROI R51 is located in the inner circle and the ROI R52 is located in the outer circle. Since the original image quality of the image inside the ROI R51 will be maintained, the processing level parameter LV0 can be set to a first processing level parameter (such as the 0-th order). Since the image quality of the image between the ROIs R51 and R52 will be reduced, the processing level parameter LV1 can be set to a second processing level parameter (such as the first order). Since the image quality of the image outside the ROI R52 will be further reduced, the processing level parameter LV2 can be set to a third processing level parameter (such as the second order). The first processing level parameter is lower than the second processing level parameter, and the second processing level parameter is lower than the third processing level parameter. The processing level parameter is positively relevant to the reduction in image quality. That is, the higher the processing level parameter, the worse the deterioration in image quality, and vice versa.

In an embodiment of the present invention, the processing level parameter is also positively relevant to a distance (parameter), and the distance (parameter) which refers to the distance between the target pixel or the target block and the ROI, or the distance between the target pixel or the target block and a center position of the ROI.

In an embodiment of the present invention, the processing level parameter can be a continuous value (such as floating point) or a discontinuous value (fixed, such as an integer). That is, the value of the processing level parameter can be a continuous value or a discontinuous value.

For the convenience of description, here below the shape of the ROI is exemplified by a circle, but the present invention is not limited thereto.

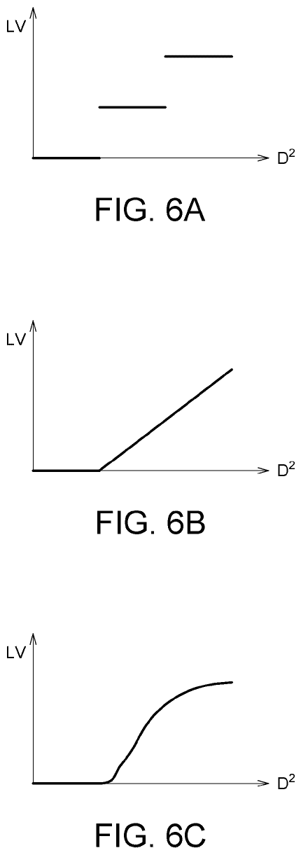

FIG. 6A to FIG. 6C are schematic diagrams of processing level parameters according to an embodiment of the present invention. For the convenience of description, here below it is exemplified that processing level parameter is relevant to a distance parameter, but the present invention is not limited thereto.

In FIG. 6A to FIG. 6C, the processing level parameter can be represented by LV=F(D), wherein, LV represents a processing level parameter, and D represents a distance parameter. F(D) can be represented by a formula or obtained by looking up table. In FIG. 6A, the processing level parameter is discontinuous. In FIG. 6B, the processing level parameter is continuous and linear. In FIG. 6C, the processing level parameter is continuous and non-linear.

In a possible example of the present invention, D can be expressed as: D=\sqrt{(x−xc)²+(y−yc)²}, wherein, xc and yc respectively represent the value of x coordinate and the value of y coordinate of the ROI center point; x and y respectively represents the value of x coordinate and the value of y coordinate of the target pixel or the target block. Based on the above expression, the shape of the ROI will be a circle.

In other possible examples of the present invention, D can be expressed as: D=max(abs(x−xc), abs(y−yc)). Based on the above expression, the shape of the ROI will be a square.

In other possible examples of the present invention, D can be expressed as: D=abs(x−xc)+abs(y−yc). Based on the above expression, the shape of the ROI will be a diamond.

In an embodiment of the present invention, depending on the unit, several image region processing operations can be used. Details of the pixel-based processing operation and the block-based processing operation are disclosed below. An image is virtually divided into several blocks. In an embodiment of the present invention, the block-based processing operation of the foveated processing unit 230 further includes compression and the details are disclosed below.

### Pixel-Based Processing Operation

During the pixel-based processing operation, the operation is performed in the unit of pixel, therefore the boundary of the ROI can also be defined in the unit of pixel. Under such architecture, the operation can be implemented using a filter.

In an embodiment of the present invention, during the pixel-based processing operation, the inside image region processing operation and the outside image region processing operation are performed according to the value of the processing level parameter, and all of the processed images need to be compressed by the compression unit 140.

During the pixel-based processing operation, different filters can be selected. For example, a low pass filter or any filters capable of reducing high frequency contents can be selected to reduce the volume of image compression.

In an embodiment of the present invention, a finite impulse response (FIR) filter, an infinite impulse response (IIR filter), any edge-preserved filters, such as bilateral filter or non-local means filter, a mean filter or a Gaussian filter can be selected.

In an embodiment of the present invention, a processing level parameter can be converted to a filter attribute. For example, when the mean filter is used, the processing level parameter can be converted to the filter scope of the mean filter. Or, when the Gaussian filter is used, the processing level parameter can be converted to the filter scope and/or blurring level of the Gaussian filter.

As disclosed above, a processing level parameter can be converted to a filter attribute. Here below, it is exemplified that the filter attribute is filter scope, but the present invention is not limited thereto. The filter scope is relevant to filter order. When the mean filter is used, the processing level parameter can be converted to a filter order, wherein, the higher the filter order, the larger the processing level parameter (for example, more blurred).

As disclosed above, the processing level parameter is also relevant to a distance parameter D, therefore, in an embodiment of the present invention, the relationship between the filter order and the distance parameter D can be obtained.

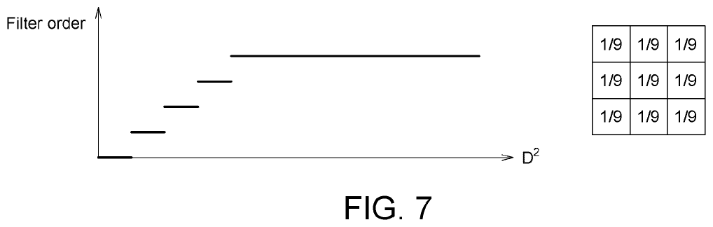

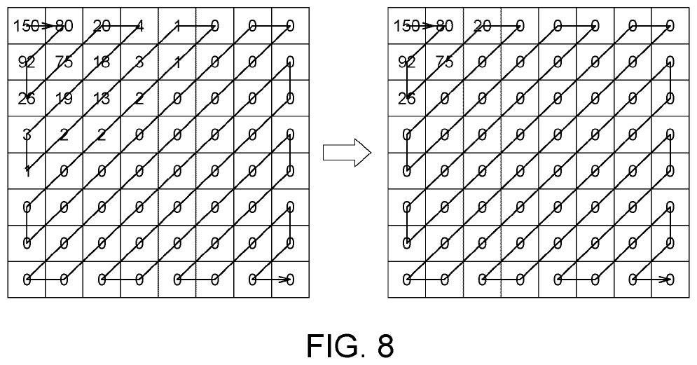

FIG. 7 is a schematic diagram illustrating the relationship between the filter order and the distance parameter D according to an embodiment of the present invention. As indicated in FIG. 7, when the processing level parameter is LV0, the filter order is also 0, which indicates that the filter can be regarded as an all-pass filter, and the image quality of the image inside the ROI can be maintained. FIG. 7 is exemplified by digital processing, and the filter order is an integer. The right-hand side of FIG. 7 illustrates the filter coefficients when the filter order is 3.

### Block-Based Processing Operation

In an embodiment of the present invention, during the block-based processing operation, different compression operations are selected according to the value of the processing level parameter, that is, different levels of image compression are respectively performed on the image inside or outside the ROI according to the value of the processing level parameter. For example, a compression operation with a lower distortion level or without distortion is performed on the image inside the ROI, and a compression operation with a higher distortion level is performed on the image outside the ROI, wherein the compression operations have different compression levels.

During the block-based processing operation, the operation is performed in the unit of block, therefore the boundary of the ROI can also be defined in the unit of block, wherein, the size of a block is such as but is not limited to 8*8 or 16*16. The said architecture conforms to the discrete cosine transform (DCT) based compression method, and therefore is used to implement the said processing operation. That is, during the block-based processing operation, images are in a compression process. When the block-based processing operation is used, the processing level parameter can be converted to a distortion attribute. In an embodiment of the present invention, the block-based processing operation can be implemented by several ways. The AC truncation method (AC represents the AC coefficients of DCT conversion) and the varied quantization parameter method are disclosed below with exemplifications, but the present invention is not limited thereto.

AC truncation can be used in all DCT-like compression operations (such as joint photographic experts group (JPEG), moving picture experts group (MPEG), H.264, and H.265). According to AC truncation, when the position of a predetermined order is reached, the AC data after the said position are truncated. That is, the truncated AC data will be erased and set to 0 to reduce the data volume.

FIG. 8 is a schematic diagram of AC truncation according to an embodiment of the present invention, wherein, each grid represents a pixel, and 8×8 pixels form a block. In the left-hand side of FIG. 8, the block data have been processed with DCT and quantization. After the pixel data inside the blocks are arranged in a zigzag manner, the pixel data is: 150 (DC, which represents the DC coefficients of DCT), 80, 92, 26, 75, 20, 4, 18, 19, 3, 1, 2, 13, 3, 1, 0, 1, 2, 2, end of block (EOB). If the AC data after the fifth position are truncated, the truncated pixel data becomes: 150 (DC), 80, 92, 26, 75, 20, and EOB.

According to the above AC truncation method, the truncation position is fixed; according to another AC truncation method of another possible embodiment of the present invention, the truncation position is not fixed, and is defined as a relevant position with a maximal non-zero AC allowance.

For example, the AC data order is: 33 (DC), 23, 0, 1, 0, 0, 0, 1, 0, 1, EOB. If the maximal non-zero AC allowance is defined as 3, then the truncated AC data order is: 33 (DC), 23, 0, 1, and EOB, because only the first 3 non-zero AC data are allowed.

As disclosed above, the processing level parameter is relevant to the distortion attribute. When the distortion attribute is truncation position (the AC data after the truncation position are erased and set to 0), it can be obtained that the processing level parameter is relevant to the truncation position.

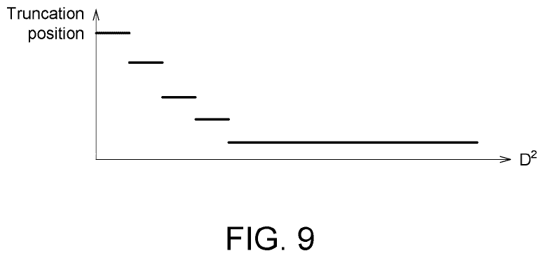

The processing level parameter can be determined according to the distance parameter D, therefore the distance parameter D, the processing level parameter and the truncation position are relevant. In an embodiment of the present invention, it can be obtained that the truncation position is relevant to the distance parameter. FIG. 9 is a schematic diagram illustrating the relationship between the truncation position and the distance parameter according to an embodiment of the present invention. For example, when the size of a block is 8*8 (1 DC data and 63 AC data), the distance parameter D of 0 (the processing level parameter is 0) indicates that the truncation position is 63, that is, no AC data is truncated, and the rest can be obtained by the same analogy. The larger the distance parameter D, the earlier the truncation position (that is, more AC data will be truncated).

Apparently, the above AC truncation method can reduce the block data as well as the data size after compression.

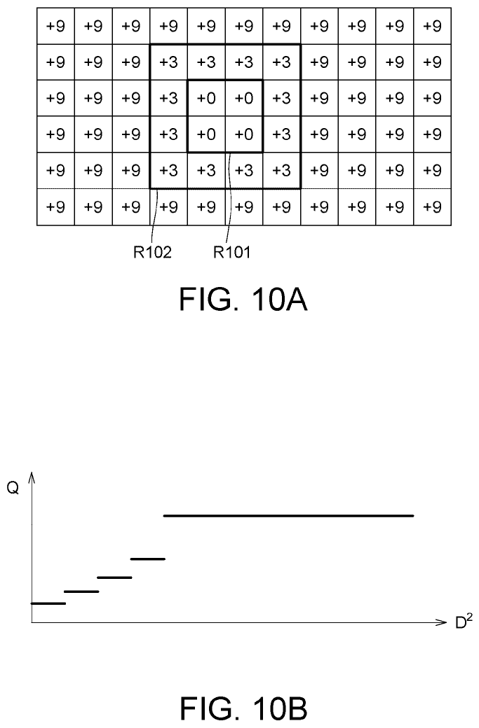

Descriptions of the varied quantization parameter method are disclosed below. In the varied quantization parameter method, the quantization parameter Q or the quantization parameter increment can be individually and independently adjusted for each block. FIG. 10A is a schematic diagram of the quantization parameter Q or the quantization parameter increment of each block according to an embodiment of the present invention. FIG. 10B is a schematic diagram illustrating the relationship between the quantization parameter Q and the distance parameter D according to an embodiment of the present invention.

In FIG. 10A, each grid represents a block. The quantization parameter increment of the blocks inside the first ROI R101 can be set to a first value (such as 0, which represents that the predetermined compression quality is maintained), the quantization parameter increment of the blocks between the first ROI R101 and the second ROI R102 can be set to a second value (such as but not limited to +3, which represents a lower loss in compression quality in comparison to the predetermined compression quality), the quantization parameter increment of the blocks outside the second ROI R102 can be set to a third value (such as but not limited to +9, which represents a higher loss in compression quality in comparison to the predetermined compression quality), wherein, the third value greater than the second value, and the second value greater than the first value. In other embodiments of the present invention, the blocks between the first ROI R101 and the second ROI R102 can have different quantization parameter increments, but the quantization parameter increments need to be greater than the first value. In other embodiments of the present invention, the blocks outside the second ROI R102 can have different quantization parameter increments, but the quantization parameters increment need to be greater than the quantization parameter increments of the blocks between the first ROI R101 and the second ROI R102. In FIG. 10A, the larger the Q value (or the quantization parameter increment), the higher the distortion level/blurring, and the smaller the data size after compression. The shape and scope of the first ROI R101 and the second ROI R102 can also be changed according to actual needs and are still within the spirit of the scope of the present invention.

That is, in the varied quantization parameter method, the quantization parameter increments of the blocks of the image are individually adjusted (that is, the blocks can have different quantization parameter increments), such that the quantization parameter increments of the blocks inside the ROI are lower than the quantization parameter increments of the blocks outside the ROI.

As disclosed above, the processing level parameter is relevant to distortion attribute. When the distortion attribute is quantization parameter Q, it can be obtained that the processing level parameter is relevant to the quantization parameter Q.

The processing level parameter can be determined according to the distance parameter D, therefore the distance parameter D, the processing level parameter and the quantization parameter Q are relevant. In an embodiment of the present invention, it can be obtained that the quantization parameter Q is relevant to the distance parameter. That is, the distance parameter can be converted to the quantization parameter Q. As indicated in FIG. 10B, when the distance parameter=0 (the processing level parameter LV is the 0-th order), the quantization parameter Q is 0; the larger the distance parameter D, the larger the quantization parameter Q, and the higher the data compression ratio.

In other possible embodiments of the present invention, the change of the quantization parameter Q can be relevant to rate control (RC). That is, (1) the ROI affects RC mechanism, which determines the value of the quantization parameter (or the quantization parameter increment) according to the ROI, or (2) the quantization parameter Q is pre-set according to the result of RC mechanism, then the quantization parameter increment of each block is set according to the above method.

Apparently, the varied quantization parameter method can reduce the data size after compression.

In other possible embodiments of the present invention, when the captured image signal is an analog signal, an ROI is defined in the analog image (but is not in the unit of pixel because the image is analog), a processing operation (for example, a blurring operation) is performed on the region outside the ROI by an analog filter, then the analog image is converted into a digital signal and a compression operation is performed on the digital signal.

In an embodiment of the present invention, after a to-be-tracked object is detected through image analysis, a position of the ROI is determined according to the position of the to-be-tracked object.

To summarize, in an embodiment of the present invention, by maintaining the image quality of the image inside the ROI (the image inside the ROI is not processed or is processed by predetermined distortion compression) and performing an outside image region processing operation on the image outside the ROI (for example, the image outside the ROI is blurred or the distortion level after compression is increased), the present invention can increase the image compression ratio and reduce data transmission time, and still can be used even when the bandwidth of the VR/AR internal transmission is restricted.

To summarize, in an embodiment of the present invention, by maintaining the image quality of the image inside the ROI (the image inside the ROI is not processed or is processed by predetermined distortion compression) and performing an outside image region processing operation on the image outside the ROI (for example, the image outside the ROI is blurred or the distortion level after compression is increased), the present invention can improve the user's experience of use because the image quality of the image inside the ROI remains unchanged when the user is viewing the image inside the ROI.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A two-dimension (2D) array image foveated processing method, comprising:
determining an user eye watching area around a user eye watching point on a display unit;
generating a region of interest (ROI) of a 2D array image, displayed by the display unit, based on the user eye watching area;
generating a processing level parameter of a target pixel or a target block in the 2D array image according to a distance relationship between the target pixel or the target block in the 2D array image and the ROI; and
respectively performing an inside image region processing operation or an outside image region processing operation on the target pixel or the target block inside or outside the ROI according to the processing level parameter.

2. The 2D array image foveated processing method according to claim 1, wherein a center point of the ROI of the 2D array image is relevant to the user eye watching point on the display unit.

3. The 2D array image foveated processing method according to claim 1, wherein, the inside image region processing operation or the outside image region processing operation respectively performed on the target pixel or the target block inside or outside the ROI according to the processing level parameter is a pixel-based processing operation; and
performing an image compression operation on the processed image.

4. The 2D array image foveated processing method according to claim 3, wherein, when performing an inside image region processing operation or an outside image region processing operation respectively on the target pixel inside or outside the ROI according to the processing level parameter, the processing level parameter is converted to a filter attribute, a filter scope and/or a blurring level.

5. The 2D array image foveated processing method according to claim 1, wherein,
the inside image region processing operation or the outside image region processing operation respectively performed on the target pixel or the target block inside or outside the ROI according to the processing level parameter is a block-based processing operation; and
different levels of image compression are respectively performed on the target pixel or the target block outside the ROI according to the processing level parameter.

6. The 2D array image foveated processing method according to claim 5, further comprising:
individually and independently adjusting a quantization parameter or a quantization parameter increment for each of a plurality of blocks in the 2D array image, such that the quantization parameters or the quantization parameter increment of the blocks inside the ROI is lower than the quantization parameter or the quantization parameter increment of the blocks outside the ROI;
a change of the quantization parameter is relevant to rate control; and
when the 2D array image is an analog image, processing the target pixel or the target block outside the ROI by an analog filter, converting the processed analog image to a digital image and compressing the digital image.

7. The 2D array image foveated processing method according to claim 1, wherein when performing the inside image region processing operation, image quality of the target pixel or the target block inside the ROI is substantially maintained; when performing the outside image region processing operation, image quality of the target pixel or the target block outside the ROI is substantially blurred or distorted.

8. The 2D array image foveated processing method according to claim 1, wherein, the processing level parameter is positively relevant to a distance parameter, the distance parameter is relevant to a distance between the target pixel or the target block and the ROI or a distance between the target pixel or the target block and a center position of the ROI; and the processing level parameter is a continuous value or a discontinuous value.

9. The 2D array image foveated processing method according to claim 1, wherein the shape of the ROI is a symmetrical pattern, and the center point of the ROI is a geometric center of the symmetrical pattern.

10. An electronic device with 2D array image foveated processing, comprising:
a display unit;
a eye tracking unit for determining an user eye watching area around a user eye watching point on the display unit; and
a foveated processing unit used for generating a region of interest (ROI) of a 2D array image, generating a processing level parameter of a target pixel or a target block in the 2D array image according to a distance relationship between the target pixel or the target block in the 2D array image and the ROI, and respectively performing an inside image region processing operation or an outside image region processing operation on the target pixel or the target block inside or outside the ROI according to the processing level parameter;
wherein the 2D array image is displayed by the display unit, and the foveated processing unit generates the ROI based on the user eye watching area.

11. The electronic device according to claim 10, wherein a center point of the ROI of the 2D array image is relevant to the user eye watching point on the display unit.

12. The electronic device according to claim 10, wherein,
the inside image region processing operation or the outside image region processing operation respectively performed on the target pixel or the target block inside or outside the ROI by the foveated processing unit according to the processing level parameter is a pixel-based processing operation; and
the electronic device further comprises a compression unit used for performing an image compression operation on the processed image.

13. The electronic device according to claim 12, wherein, when the foveated processing unit respectively performs the inside image region processing operation or the outside image region processing operation on the target pixel inside or outside the ROI according to the processing level parameter, the foveated processing unit converts the processing level parameter to a filter attribute, a filter scope and/or a blurring level.

14. The electronic device according to claim 10, wherein,
the inside image region processing operation or the outside image region processing operation respectively performed on the target pixel or the target block inside or outside the ROI by the foveated processing unit according to the processing level parameter is a block-based processing operation; and
the foveated processing unit respectively performs different levels of image compression on the target pixel or the target block outside the ROI according to the processing level parameter.

15. The electronic device according to claim 14, wherein,
a quantization parameter or a quantization parameter increment is individually and independently adjusted for each of a plurality of blocks in the 2D array image, such that the quantization parameters or the quantization parameter increment of the blocks inside the ROI is lower than the quantization parameter or the quantization parameter increment of the blocks outside the ROI;
a change of the quantization parameter is relevant to rate control; and
when the 2D array image is an analog image, the target pixel or the target block outside the ROI is processed by an analog filter, the processed analog image is converted to a digital image and the digital image is compressed.

16. The electronic device according to claim 10, wherein, when performing the inside image region processing operation, image quality of the target pixel or the target block inside the ROI is substantially maintained; when performing the outside image region processing operation, image quality of the target pixel or the target block outside the ROI is substantially blurred or distorted.

17. The electronic device according to claim 10, wherein,
the processing level parameter is positively relevant to a distance parameter, the distance parameter is relevant to a distance between the target pixel or the target block and the ROI; and
the processing level parameter is a continuous value or a discontinuous value.

18. The electronic device according to claim 10, wherein the shape of the ROI is a symmetrical pattern, and the center point of the ROI is a geometric center of the symmetrical pattern.
